(19) United States
(12) Patent Application Publication
(10) Pub. No.: US 2014/0156236 A1
(43) Pub. Date: Jun. 5, 2014

(54) MODELING MULTIPLE INTERACTIONS BETWEEN MULTIPLE LOCI

(71) Applicant: International Business Machines Corporation, Armonk, NY (US)

(72) Inventors: David C. HAWS, New York, NY (US); Dan HE, Ossining, NY (US); Laxmi P. PARIDA, Mohegan Lake, NY (US)

(73) Assignee: International Business Machines Corporation, Armonk, NY (US)

(21) Appl. No.: 14/030,787

(22) Filed: Sep. 18, 2013

Related U.S. Application Data
(63) Continuation of application No. 13/705,738, filed on Dec. 5, 2012.

(51) Int. Cl. G06F 19/12

(52) U.S. Cl. CPC G06F 19/12
USPC 703/2

(57) ABSTRACT

Various embodiments generate a quantitative model of genetic effect. In one embodiment, a processor receives a set of loci of an entity. Each locus is associated with a contribution value to a given physical trait. A first set of interacting loci associated with a first interaction and at least a second set of interacting loci associated with at least a second interaction are identified. The first interaction type is associated with a first interaction model. The at least the second interaction is associated at least a second interaction model. A model of a quantitative value of the entity is generated based on at least the contribution value associated with each locus in the set of loci, a contribution value of the first interaction as defined by the first interaction model, and a contribution value of the second interaction as defined by the at least the second interaction model.

### CROSS-REFERENCE TO RELATED APPLICATIONS

This application is based upon and claims priority from prior U.S. patent application Ser. No. 13/705,738, filed on Dec. 5, 2012, now U.S. Pat. No. ______, the entire disclosure of which is herein incorporated by reference in its entirety.

### BACKGROUND

The present invention generally relates to the field of computational biology, and more particularly relates to modeling interactions between genes.

Nearly all physical characteristics of an organism can be partially explained by its genetic code. The genetic code (genome) of an organism is composed of multiple chromosomes, and each chromosome contains many genes (loci). Each genome includes two copies of each gene, and each gene may have multiple forms called alleles. The allelic composition of the genomes among individuals in a population (e.g. humans) can explain a wide variety of differing characteristics such as eye color. Quantitative models can be used describe how alleles contribute to a physical trait. However, most conventional models generally model the contribution of each locus independently and assume the same model for each interaction.

### BRIEF SUMMARY

In one embodiment, a computer implemented method for generating a quantitative model of genetic effect is disclosed. The method includes receiving, by a processor, a set of loci of an entity. Each locus in the set of loci is associated with a contribution value to a given physical trait. A first set of interacting loci associated with a first interaction and at least a second set of interacting loci associated with at least a second interaction are identified from the set of loci. The first interaction type is associated with a first interaction model. The second interaction type is associated at least a second interaction model. A model of a quantitative value of the entity is generated based on at least the contribution value associated with each locus in the set of loci, a contribution value of the first interaction as defined by the first interaction model, and a contribution value of the at least the second interaction as defined by the at least the second interaction model.

In another embodiment, an information processing system for generating a quantitative model of genetic effect is disclosed. The information processing system includes a memory and a processor that is communicatively coupled to the memory. An interaction model generator is communicatively coupled to the memory and the processor. The interaction model generator is configured to perform a method. The method includes receiving a set of loci of an entity. Each locus in the set of loci is associated with a contribution value to a given physical trait. A first set of interacting loci associated with a first interaction and at least a second set of interacting loci associated with at least a second interaction are identified from the set of loci. The first interaction type is associated with a first interaction model. The second interaction type is associated at least a second interaction model. A model of a quantitative value of the entity is generated based on at least the contribution value associated with each locus in the set of loci, a contribution value of the first interaction as defined by the first interaction model, and a contribution value of the at least the second interaction as defined by the at least the second interaction model.

In a further embodiment, a computer program product for generating a quantitative model of genetic effect is disclosed is disclosed. The computer program product includes a storage medium readable by a processing circuit and storing instructions for execution by the processing circuit for performing a method. The method includes receiving a set of loci of an entity. Each locus in the set of loci is associated with a contribution value to a given physical trait. A first set of interacting loci associated with a first interaction and at least a second set of interacting loci associated with at least a second interaction are identified from the set of loci. The first interaction type is associated with a first interaction model. The second interaction type is associated at least a second interaction model. A model of a quantitative value of the entity is generated based on at least the contribution value associated with each locus in the set of loci, a contribution value of the first interaction as defined by the first interaction model, and a contribution value of the at least the second interaction as defined by the at least the second interaction model.

### BRIEF DESCRIPTION OF THE SEVERAL VIEWS OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention, in which:

FIG. 1 is a block diagram illustrating one example of an operating environment according to one embodiment of the present invention;

FIG. 2 illustrates a first example of an interaction model for bi-allelic loci according to one embodiment of the present invention;

FIG. 3 illustrates a second example of an interaction model for bi-allelic loci according to one embodiment of the present invention;

FIG. 4 illustrates a third example of an interaction model for bi-allelic loci according to one embodiment of the present invention;

FIG. 5 illustrates a fourth example of an interaction model for bi-allelic loci according to one embodiment of the present invention;

FIG. 6 illustrates a sixth example of an interaction model for bi-allelic loci according to one embodiment of the present invention;

FIG. 7 illustrates a first example of a dominance-based interaction model for bi-allelic loci according to one embodiment of the present invention;

FIG. 8 illustrates a second example of a dominance-based interaction model for bi-allelic loci according to one embodiment of the present invention;

FIG. 9 shows a first example of an interaction model for multi-allelic loci according to one embodiment of the present invention;

FIG. 10 shows a second example of an interaction model for multi-allelic loci according to one embodiment of the present invention;

FIG. 11 illustrates one example of a dominance-based interaction model for multi-allelic loci according to one embodiment of the present invention; and

FIG. 12 is an operational flow diagram illustrating one example of generating a quantitative model of genetic effect according to one embodiment of the present invention.

### DETAILED DESCRIPTION

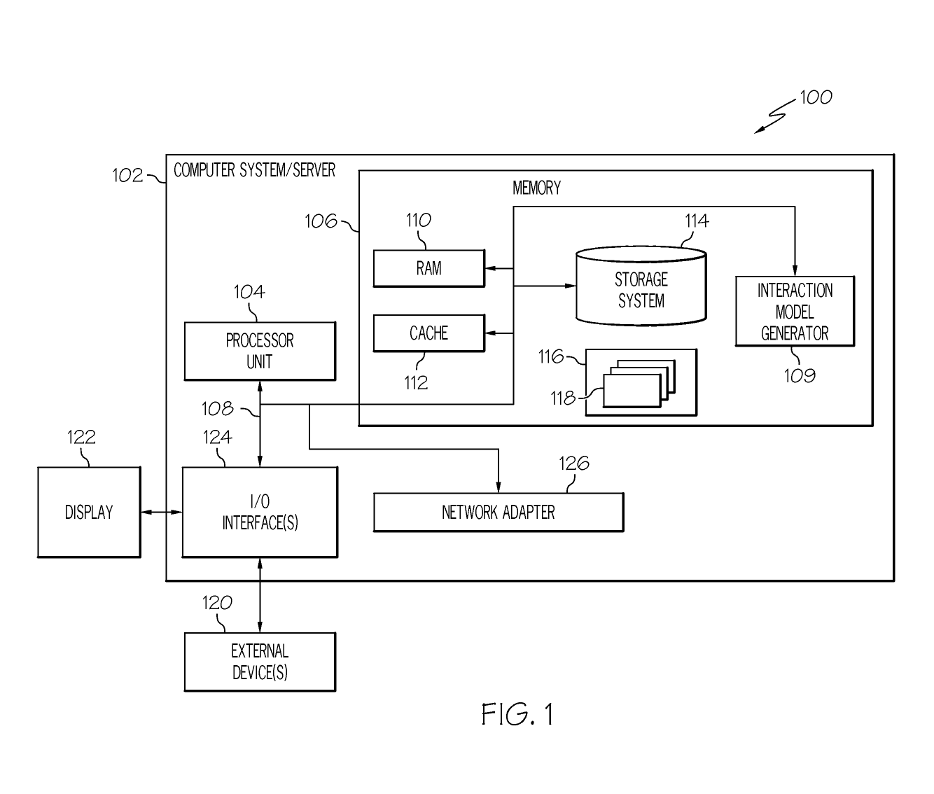

FIG. 1 illustrates a general overview of one operating environment 100 for generating quantitative models of multi-allelic multi-loci interactions for genetic simulation and prediction problems according to one embodiment of the present invention. In particular, FIG. 1 illustrates an information processing system 102 that can be utilized in embodiments of the present invention. The information processing system 102 shown in FIG. 1 is only one example of a suitable system and is not intended to limit the scope of use or functionality of embodiments of the present invention described above. The information processing system 102 of FIG. 1 is capable of implementing and/or performing any of the functionality set forth above. Any suitably configured processing system can be used as the information processing system 102 in embodiments of the present invention.

As illustrated in FIG. 1, the information processing system 102 is in the form of a general-purpose computing device. The components of the information processing system 102 can include, but are not limited to, one or more processors or processing units 104, a system memory 106, and a bus 108 that couples various system components including the system memory 106 to the processor 104.

The bus 108 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

The system memory 106, in one embodiment, includes an interaction model generator 109 configured to perform one or more embodiments discussed below. For example, in one embodiment, the interaction model generator 109 is configured to generate quantitative models of genetic effect with main effects (non-interactions) and interactions, where each interaction can be of a different type. The interaction model generator 109 is discussed in greater detail below. It should be noted that even though FIG. 1 shows the interaction model generator 109 residing in the main memory, the interaction model generator 109 can reside within the processor 104, be a separate hardware component, and/or be distributed across a plurality of information processing systems and/or processors

The system memory 106 can also include computer system readable media in the form of volatile memory, such as random access memory (RAM) 110 and/or cache memory 112. The information processing system 102 can further include other removable/non-removable, volatile/non-volatile computer system storage media. By way of example only, a storage system 114 can be provided for reading from and writing to a non-removable or removable, non-volatile media such as one or more solid state disks and/or magnetic media (typically called a “hard drive”). A magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus 108 by one or more data media interfaces. The memory 106 can include at least one program product having a set of program modules that are configured to carry out the functions of an embodiment of the present invention.

Program/utility 116, having a set of program modules 118, may be stored in memory 106 by way of example, and not limitation, as well as an operating system, one or more application programs, other program modules, and program data. Each of the operating system, one or more application programs, other program modules, and program data or some combination thereof, may include an implementation of a networking environment. Program modules 118 generally carry out the functions and/or methodologies of embodiments of the present invention.

The information processing system 102 can also communicate with one or more external devices 120 such as a keyboard, a pointing device, a display 122, etc.; one or more devices that enable a user to interact with the information processing system 102; and/or any devices (e.g., network card, modem, etc.) that enable computer system/server 102 to communicate with one or more other computing devices. Such communication can occur via I/O interfaces 124. Still yet, the information processing system 102 can communicate with one or more networks such as a local area network (LAN), a general wide area network (WAN), and/or a public network (e.g., the Internet) via network adapter 126. As depicted, the network adapter 126 communicates with the other components of information processing system 102 via the bus 108. Other hardware and/or software components can also be used in conjunction with the information processing system 102. Examples include, but are not limited to: microcode, device drivers, redundant processing units, external disk drive arrays, RAID systems, tape drives, and data archival storage systems.

Gene by gene epistasis is the interaction of multiple loci, which contribute to the effect of a phenotype, such that the total effect cannot be attributed to the marginal effects alone. Given this broad definition, there are many models of epistasis. This flexibility is more likely to capture reality than the rigid model of the same interaction model for all the interactions. Traditionally models of genetic effect generally assume that all the k-way epistasis interactions use the same interaction model. However, many biological traits may in fact involve multiple epistasis interactions in which each interaction operates under a different model. Two loci may interact in many ways and moreover they may be multi-allelic, yielding even more models. Therefore, one or more embodiments of the preset invention model an overall genetic effect with main effects (non-interactions) along with some fixed set of interactions. For each k-way interaction the genetic effects model allows for any number of epistasis interaction models.

In one embodiment, quantitative values are associated with categorical genotypes. For example, consider the bi-allelic (a, A) locus where the possible genotypes in a diploid are aa, AA and aA. An assumption is made that the quantitative contribution of aA is the arithmetic mean of aa and AA. The quantities associated with aa and AA determine whether aa and AA have a positive contribution or negative contribution, respectively, on the physical trait being simulated. For example, let r be some positive real number associated with this specific locus and the quantitative values of aa, aA, and AA be −r, 0, and +r, respectively. That is, aa has a negative contribution on the physical trait, AA has a positive contribution on the physical trait, and aA has a zero (0) contribution on the physical trait. Therefore, aa has the least contribution on the physical trait, AA has the greatest contribution on the physical trait, and aA has a contribution that is between aa and AA. Alternatively, the quantitative values of aa and AA can be +r and −r, respectively.

This leads to a natural encoding, written as e(aa) and e(AA) in the following embodiments. To summarize, the input for the bi-allelic case is only an indication that the locus is bi-allelic. Let the two alleles be, for example, a and A, then the only possible genotype values are aa, AA, and aA. For example, based on the example above, the encoding for aa is e(aa)=−r (negative impact) & e(AA)=r (positive impact). Then by convention: e(aA)=0 (0 impact). It should be the scale of the contribution of each genotype is determined by the βᵢ parameter of EQ. 4 discussed below.

In one embodiment, the quantitative value of an individual is calculated as the sum of all the values over all the loci, provided there are no interactions between the loci. The quantitative value is a quality, characteristic, etc. that can be measured or quantified on the biological organism being studied. For example, plant height, disease resistance, color, time to produce seeds, etc. In one embodiment, an error component can be added. For example, consider a fixed individual, and let the genotype at locus i of this individual be Gᵢ. Then the value v of this individual (without interactions) is:

$$v = {\sum }_{i} {r}_{i} {x}_{i} = {\sum }_{i} {β}_{i} {x}_{i} , \\ where \\ {x}_{i} = e ( {G}_{i} ) . \qquad ( EQ 1 )$$

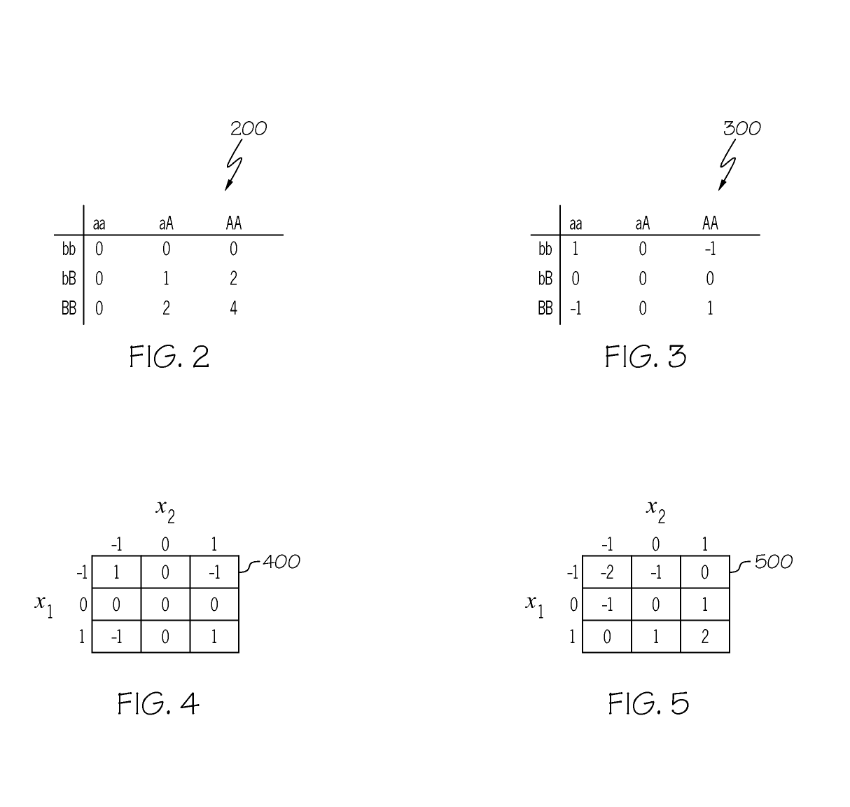

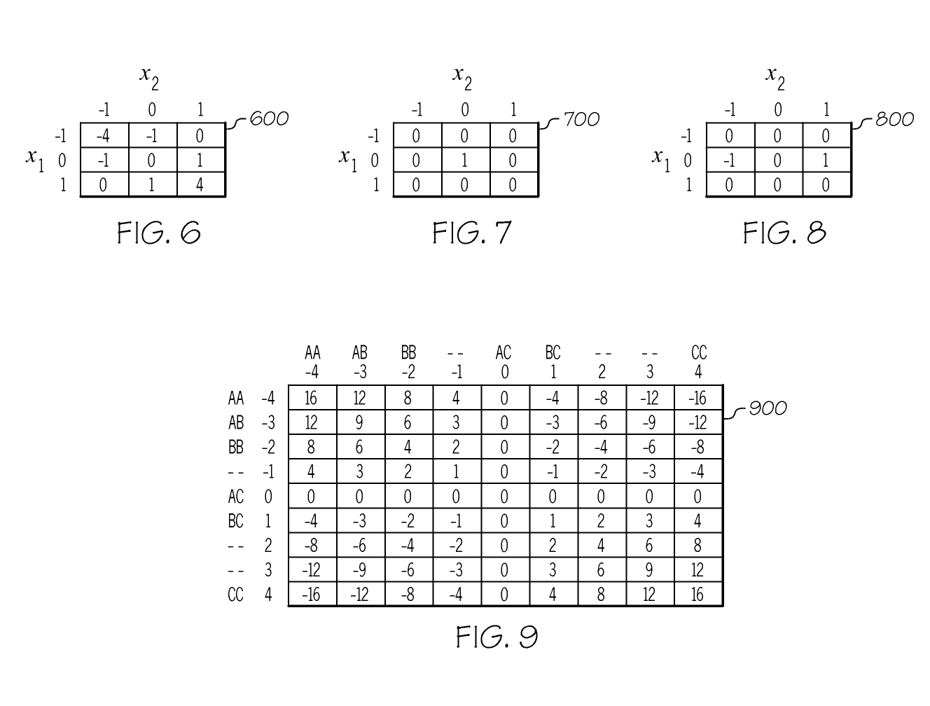

As discussed above, many biological traits can involve multiple epistasis interactions in which each interaction operates under a different interaction model. For example, consider two bi-allelic loci, one model 200 of their interaction contribution is shown in FIG. 2, while another model 300 is shown in FIG. 3. Each of these models 200, 300 interprets a different type of biological interaction between the two loci. FIGS. 4-11 show additional examples of interaction models. It should be noted that embodiments of the present invention are not limited to these examples, and any interaction model is applicable to embodiments of the present invention.

In particular, FIGS. 4-6 show various bi-allelic loci interaction models 400, 500, 600. Each of these models 400, 500, 600 is a 2-way interaction model since they are modeling interactions between two genes x₁ and x₂. In particular, FIG. 4 shows a first model, Model E1 400, which is a minimal (3-grain) 2-way interaction model. The outer positions 402, 404 on the x-axis and y-axis of the E1 model 400 are associated with the possible genotypes of genes x₂ and x₁, respectively. For example, for the bi-allelic locus (a, A) x₁ and x₂ each of these positions corresponds to aa, aA, and AA going from left to right on the x-axis and top to bottom on the y-axis. The values at each of these outer positions represent the contributions of a genotype to the physical trait being simulated. Each position 406 within the E1 model 400 indicates the contribution of the interaction between the two corresponding genotypes on the physical trait being simulated. For example, the contribution of the interaction between genotype aa for gene x₁ and genotype aa for gene x₂ is 0 based on the E1 model 400. In one embodiment, the E1 model 400 can be represented in the following closed algebraic form for 2-way interactions: x₁x₂. The E1 model 400 can also be represented in the following closed algebraic form for k-way interactions: Πxᵢ.

FIG. 5 shows a second interaction model, E2 model 500, which is a more refined (5-grain) 2-way interaction model. Similar to the E1 model 500, the outer positions 502, 504 on the x-axis and y-axis of the E2 model 500 represent the possible genotypes of each gene x₁ and x₂ and their respective contributions. Each position 506 within the E2 model 500 indicates the contribution of the interaction between the two corresponding genotypes on the physical trait being simulated. For example, considering a bi-allelic locus (a, A) for each of x₁ and x₂ with genotypes aa, aA, and AA the contribution of the interaction between genotype aa for x₁ and genotype aa for x₂ is −2. The E2 model 500 can be represented in the following closed algebraic form for 2-way interactions: x₁+x₂. The E2 model 500 can also be represented in the following closed algebraic form for k-way interactions as follows: Σxᵢ.

FIG. 600 shows a third model, E3 model 600, which is a 9-grain 2-way interaction model. Similar to the E1 and E2 models 600, 600, the outer positions 602, 1604 on the x-axis and y-axis of the E3 model 600 represent the possible genotypes of each gene x₁ and x₂ and their respective contributions. For example, for bi-allelic loci (a, A) each or these positions corresponds to aa, AA, and aA. Each position 606 within the E3 model 600 indicates the contribution of the interaction between the two corresponding genotypes on the physical trait being simulated. For example, considering a bi-allelic locus (a, A) for each of x₁ and x₂ with genotypes aa, aA, and AA the contribution of the interaction between genotype aa for xᵢ and genotype aa for x₂ is −4. The E3 model 600 can be represented in the following closed algebraic form for 2-way interactions as follows: (1+x₁x₂)(x₁+x₂). The E3 model 600 can also be represented in the following closed algebraic form for k-way interactions as follows: (1+Πxᵢ)Σxᵢ. It should be noted that some of the interaction models discussed above may increase the grain value (E2, E3 in the bi-allelic and E1, E2, E3 in the multi-allelic case). This is because the interactions may involve contributions at a finer granularity, which is translated in these models as increase in the grain value.

FIGS. 7 and 8 show dominance models with a minimum level of granularity. Dominance is specific type of interaction where on allele masks the expression (phenotype) of another allele at the same locus. FIG. 7 shows a first dominance model, D1 model 700, that models interaction with dominance in all loci. Similar to the E1, E2, and E3 models discussed above, the outer positions 702, 704 on the x-axis and y-axis of the D1 model 700 represent the possible genotypes of each gene x₁ and x₂ and their respective contributions. For example, for bi-allelic loci (a, A) each or these positions corresponds to aa, AA, and aA. Each position 706 within the D1 model 700 indicates the contribution of the interaction between the two corresponding genotypes on the physical trait being simulated. For example, considering a bi-allelic locus (a, A) for each of x₁ and x₂ with genotypes aa, aA, and AA the contribution of the interaction between genotype aa for x₁ and genotype aa for x₂ is 0. The D1 model 700 can be represented in the following closed algebraic form for 2-way interactions as follows: (1−|x₁|)(1−|x₂|). The D1 model 700 can also be represented in the following closed algebraic form for k-way interactions as follows: Π(1−|xᵢ|).

FIG. 8 shows a second dominance model, D2 model 800, that models interaction with dominance in only the first l loci (for 2-way, l=1). Similar to the E1, E2, E3, and D1 the outer positions on the x-axis and y-axis of the D2 model 800 represent the possible genotypes of each gene x₁ and x₂ and their respective contributions. For example, for bi-allelic loci (a, A) each or these positions corresponds to aa, AA, and aA. Each position 800 within the D2 model 800 indicates the contribution of the interaction between the two corresponding genotypes on the physical trait being simulated. For example, considering a bi-allelic locus (a, A) for each of x₁ and x₂ with genotypes aa, aA, and AA the contribution of the interaction between genotype aa for x₁ and genotype aa for x₂ is 0. The D2 model 800 can be represented in the following closed algebraic form for 2-way interactions: (1−|x₁|)x₂. The D2 model 800 can also be represented in the following closed algebraic form for k-way interactions as:

$${\prod }_{i = 1}^{l} ( 1 - \vert {x}_{i} \vert ) {\prod }_{i = l + 1}^{k} {x}_{i} .$$

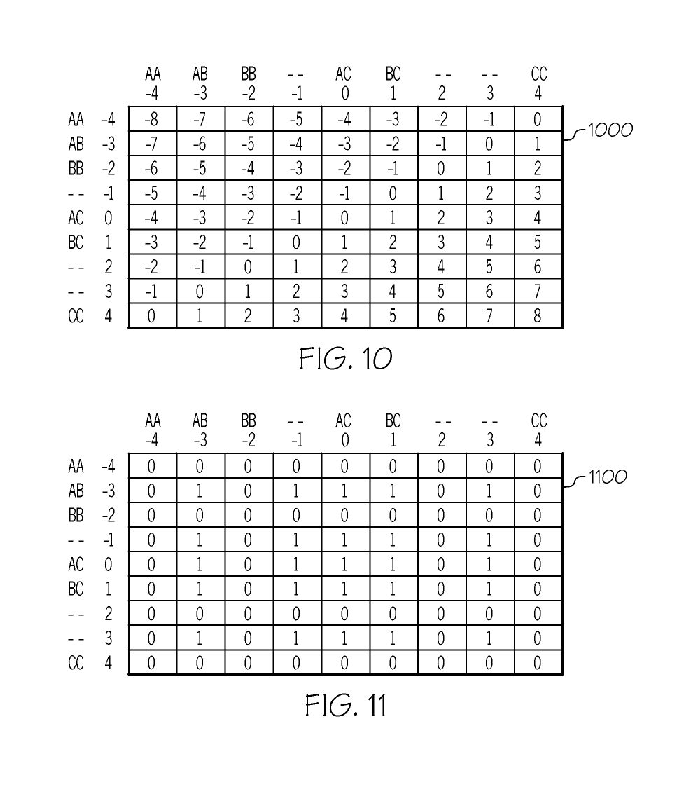

FIG. 9 shows one example of an E1 model 900 for multi-allelic loci. FIG. 10 shows one example and an E2 model 1000 for multi-allelic loci. A model similar to that of model E3 is also applicable to multi-allelic loci as well. The structure of these models 900, 1000 is similar to the models shown in FIGS. 4-6, except the models shown in FIGS. 9 and 10 are directed to multi-allelic loci. Therefore, the discussion of the structure for the models 400, 500, 600 in FIGS. 4-6 is also applicable to the models 900, 1000 shown in FIGS. 9 and 10. The algebraic representations of models E1, E2, E3 shown in FIGS. 4-6 also hold for the models shown in FIGS. 9 and 10 and a similar multi-allelic E3 model (not shown). FIG. 11 shows one example of a D1 model 11 for multi-allelic loci. The discussion of the structure for the D1 model 700 of FIG. 7 is also applicable to the D1 model 1100 shown in FIG. 11, The multi-allelic dominance model shown in FIG. 11 can be represented using the following piecewise polynomial form:

$${D}_{k} ( {x}_{{i}_{1}} , … , {x}_{{i}_{k}} ) = \{ \begin{matrix}1 , & if for each {x}_{i} , \vert {x}_{i } \vert = 0 , 1 , or 3 , \\ 0 , & otherwise .\end{matrix} \qquad ( EQ 2 )$$

It should be noted that the D2 model shown in FIG. 8 can also be extended to multi-allelic loci. For example, for multi-allelic D2 with dominance in only first l loci (for 2-way, l=1) the corresponding multi-allelic dominance model can be represented as follows:

$${D}_{k} ( {x}_{{i}_{1}} , … , {x}_{{i}_{k}} ) = f ( {x}_{{i}_{1}} , … , {x}_{{i}_{l}} ) {x}_{{i}_{l + 1}} … {x}_{{i}_{k}} , \\ where f ( {x}_{{i}_{1}} , … , {x}_{{i}_{l}} ) = \{ \begin{matrix}1 , & if for each {x}_{j} , 1 \leq j \leq l , \vert {x}_{j} \vert = 0 , 1 , or 3 , \\ 0 , & otherwise .\end{matrix} \qquad ( EQ 3 )$$

In one embodiment, the interaction model generator 109 calculates the quantitative value of an individual with main effects (non-interactions) along with a fixed set of interactions, where each interaction can be of a different type, as:

$${V}_{j} := {\sum }_{i}^{N} {β}_{i} {x}_{ij} + {\sum }_{\{ {i}_{1} , … , {i}_{k} \} = A ∈ I} {f}_{{i}_{A}} ( {x}_{{i}_{1} j} , … , {x}_{{i}_{k} j} ) \qquad ( EQ 4 )$$

for some real βᵢ. Variable j is the individual, i is a locus, βᵢ is an impact scaling factor for locus i, xᵢⱼ is the encoding of gene (locus) i of the individual j being considered, k is an integer (the number of interacting loci), I is the set of interacting loci, f is an interaction (epistasis) model, i_{A} is the set of loci A using the interaction model f. The interaction model f can be any of the interaction models discussed above, or any other interaction model. It should be noted that an individual is any entity including genes such as (but not limited to) a human, an animal, a plant, an insect, a micro-organism, etc.

EQ 4 shown above is a model of the quantitative value of an individual. Each individual j has its own composition of alleles at each locus/gene (encoded by xᵢⱼ). The scale of the effect of locus i is determined by the parameter βᵢ. If βᵢ is large then locus i has a large contribution to the quantitative value. Similarly if βᵢ is small then locus i has a small contribution to the quantitative value. Each locus/gene can individually contribute (positively or negatively) to the quantitative value (the first sum). Moreover, the loci can interact to contribute to the quantitative value (the second sum) and interactions between different loci can be of different types.

For example, the interaction model generator 109 takes as input a set of genes (loci) indexed 1, . . . , N and a set of interaction (epistasis) models {f₁, . . . , f_{M}}. The interaction model generator 109 determines/estimates which sets of loci I ⊂{A|A ⊂{1, . . . , N}} from the input set of loci 1, . . . , N are interacting, where I is the set of interacting loci. Output of this step is a set of subsets of {1, . . . , N}, i.e. I ⊂{A|A ⊂{1, . . . , N}}. Thus, I are the set of interacting loci. This determination can be based on real data (e.g., through model selection) or input from a user (e.g., as part of a simulation). For each set of interacting loci I the interaction model generator 109 determines (or assigns) which interaction model {f₁, . . . , f_{M}} to use for the interaction.

For each A∈I, the interaction model generator 109 can use real data(e.g., through model selection) to fit the best interaction model for loci A. The interaction model generator 109 can also receive a selection from a user (e.g., as part of a simulation) as to which interaction model to use for each set of loci A. Based on the above, the interaction model generator 109 generates the multi-epistasis model of quantitative trait for an individual (EQ 4 above) as the sum of the genotype encoding of each loci i multiplied by the scaling factor of loci i (βᵢ), and the sum of all sets of interacting loci (I), where for each set of interacting loci ({i₁, . . . , iₖ}=A) the predefined model of interaction (fᵢ_{_{A}}) is used, and where the epistatic effect is added using this model for this set of loci. The final multi-epistasis model of quantitative trait value, which is defined by EQ 4 above, can then be used with real data to estimate remaining parameters and predict future values. Also, a user can decide the values for remaining parameters (e.g., sample from some distribution) and use the model, for example, to simulate quantitative value for some population data.

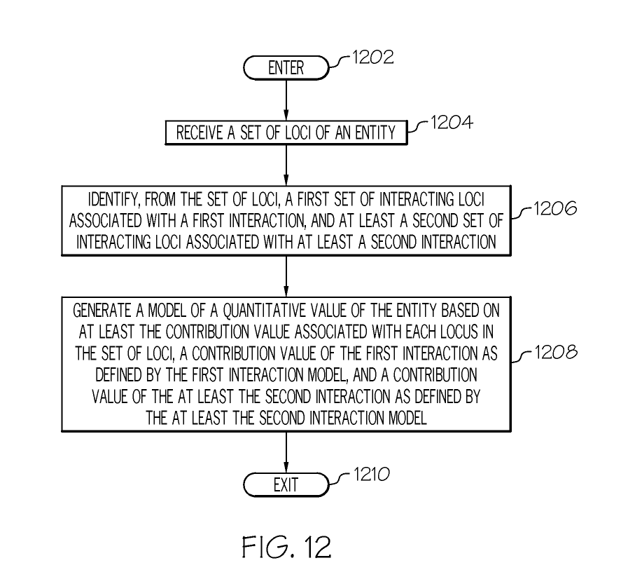

FIG. 12 is an operational flow diagram illustrating one example of an overall process for generating a quantitative model of genetic effect. The operational flow diagram begins at step 12 and flows directly to step 1204. The interaction model generator 109, at step 1204, receives a set of loci of an entity. Each locus in the set of loci is associated with a contribution value to a given physical trait. The interaction model generator 109, at step 1206, identifies, from the set of loci, a first set of interacting loci associated with a first interaction, and at least a second set of interacting loci associated with at least a second interaction. The first interaction type is associated with a first interaction model. The at least second interaction type is associated with at least a second interaction model that is the same or different from the first interaction model. The interaction model generator 109, at step 1208, generates a model of a quantitative value of the entity based on the contribution value associated with each locus in the set of loci, a contribution value of the first interaction as defined by the first interaction model, and a contribution value of the at least the second interaction as defined by the at least the second interaction model. The control flow exits at step 1210.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention have been discussed above with reference to flowchart illustrations and/or block diagrams of methods, apparatus (systems) and computer program products according to various embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. An information processing system for generating a quantitative model of genetic effect, the information processing system comprising:
a memory;
a processor communicatively coupled to the memory; and
an interaction model generator communicatively coupled to the memory and the processor, wherein the interaction model generator is configured to perform a method comprising:
receiving a set of loci of an entity, wherein each locus in the set of loci is associated with a contribution value to a given physical trait;
identifying, from the set of loci, a first set of interacting loci associated with a first interaction and at least a second set of interacting loci associated with at least a second interaction, wherein the first interaction is associated with a first interaction model, and wherein the at least the second interaction is associated at least a second interaction model;
generating a model of a quantitative value of the entity based on at least
the contribution value associated with each locus in the set of loci,
a contribution value of the first interaction as defined by the first interaction model, and
a contribution value of the at least the second interaction as defined by the at least the second interaction model.

2. The information processing system of claim 1, wherein the model of the quantitative value is defined as a
$${V}_{j} := {\sum }_{i}^{N} {β}_{i} {x}_{ij} + {\sum }_{\{ {i}_{1} , … , {i}_{k} \} = A ∈ I} {f}_{{i}_{A}} ( {x}_{{i}_{1} j} , … , {x}_{{i}_{k} j} )$$
where Vⱼ is the model of the quantitative value, j is an entity, Variable j is the individual, i is a locus, N is a real number, βᵢ is an impact scaling factor for locus i, xᵢⱼ is a contribution encoding of locus i, k is an integer identifying a number of interacting loci, I is a set of interacting loci, f is an interaction model, and i_{A} is a set of loci A using the interaction model f.

3. The information processing system of claim 1, wherein the method further comprises:
identifying at least one of the first set of interacting loci and the at least the second set of interacting loci are from real data.

4. The information processing system of claim 1, wherein the first set of interacting loci and the at least the second set of interacting loci are identified based on input received from a user.

5. The information processing system of claim 1, wherein the method further comprises:
determining that at least one of the first interaction model and the at least the second interaction model are associated with the first interaction and the at least the second interaction, respectively, based on real data.

6. The information processing system of claim 1, wherein the method further comprises:
receiving, from a user, at least one of
an association of the first interaction model with the first interaction, and
an association of the at least the second interaction model with the at least the second interaction.

7. A computer program product for generating a quantitative model of genetic effect, the computer program product comprising:
a storage medium readable by a processing circuit and storing instructions for execution by the processing circuit for performing a method comprising:
receiving a set of loci of an entity, wherein each locus in the set of loci is associated with a contribution value to a given physical trait;
identifying, from the set of loci, a first set of interacting loci associated with a first interaction and at least a second set of interacting loci associated with at least a second interaction, wherein the first interaction is associated with a first interaction model, and wherein the at least the second interaction is associated at least a second interaction model;
generating a model of a quantitative value of the entity based on at least
the contribution value associated with each locus in the set of loci,
a contribution value of the first interaction as defined by the first interaction model, and
a contribution value of the at least the second interaction as defined by the at least the second interaction model.

8. The computer program product of claim 7, wherein the model of the quantitative value is defined as a
$${V}_{j} := {\sum }_{i}^{N} {β}_{i} {x}_{ij} + {\sum }_{\{ {i}_{1} , … , {i}_{k} \} = A ∈ I} {f}_{{i}_{A}} ( {x}_{{i}_{1} j} , … , {x}_{{i}_{k} j} )$$
where Vⱼ is the model of the quantitative value, j is an entity, Variable j is the individual, i is a locus, N is a real number, βᵢ is an impact scaling factor for locus i, xᵢⱼ is a contribution encoding of locus i, k is an integer identifying a number of interacting loci, I is a set of interacting loci, f is an interaction model, and i_{A} is a set of loci A using the interaction model f.

9. The computer program product of claim 7, wherein the method further comprises:
identifying at least one of the first set of interacting loci and the at least the second set of interacting loci are from real data.

10. The computer program product of claim 7, wherein the first set of interacting loci and the at least the second set of interacting loci are identified based on input received from a user.

11. The computer program product of claim 7, wherein the method further comprises:
determining that at least one of the first interaction model and the at least the second interaction model are associated with the first interaction and the at least the second interaction, respectively, based on real data.

12. The computer program product of claim 7, wherein the method further comprises:
receiving, from a user, at least one of
an association of the first interaction model with the first interaction, and
an association of the at least the second interaction model with the at least the second interaction.
